(19) United States
(12) Patent Application Publication
(10) Pub. No.: US 2013/0223436 A1
(43) Pub. Date: Aug. 29, 2013

(54) SYSTEMS AND METHODS OF PROVIDING COMMUNICATIONS ON A SOFTWARE PLATFORM

(71) Applicant: VONAGE NETWORK LLC, (US)

(72) Inventor: TZAHI EFRATI, HOBOKEN, NJ (US)

(73) Assignee: VONAGE NETWORK LLC, Holmdel, NJ (US)

(21) Appl. No.: 13/857,621

(22) Filed: Apr. 5, 2013

Related U.S. Application Data
(63) Continuation-in-part of application No. 13/324,505, filed on Dec. 13, 2011.

(51) Int. Cl. H04L 29/06

(52) U.S. Cl. CPC H04L 65/1069
USPC 370/352

(57) ABSTRACT

A computer implemented method of delivering a message is disclosed. The method includes generating a call activation interface on a software platform. The call activation interface is associated with at least one discrete item from a plurality of discrete items on the software platform. The method further includes presenting a list of a plurality of contacts in response to a selection of the call activation interface, receiving at least one contact from the list, and generating a call setup request directed to the at least one contact. The call setup request includes an announcement message that includes information associated with the discrete item.

### CROSS REFERENCE TO RELATED APPLICATION

This application is a continuation-in-part to application Ser. No. 13/324,505 whose filing date is Dec. 13, 2011.

### BACKGROUND OF THE INVENTION

The invention is related to Internet protocol (IP) telephony systems that allow users to place and receive telephone calls, and to send and receive text and video messages via data packets that are communicated over a data network.

Presently, when a call is being setup between a calling party and a called party, caller ID information may be displayed to the called party on a display screen of the called party's telephony device. The caller ID information can include the telephone number of the calling party, and sometimes the name of the individual or business associated with that telephone number.

Also, it is now common for a telephony device to store an address book or a list of contacts for the user. This information often includes the names and telephone numbers of various people with whom the user is acquainted. When this information is available on the telephony device, and when the telephone number of the calling party is provided during call setup, the telephony device can perform a lookup to see if the telephone number of the calling party matches any of the telephone numbers present in the user's address book or contact list. If so, the name entered into the address book or contact list that is associated with the calling party's telephone number may be displayed to the user so that the user knows who is calling.

In either of the above scenarios, when the called party receives an incoming call, the called party can make a decision about whether to answer the call based on the information being displayed. Unfortunately, the called party will only receive an indication of the telephone number of the calling party, or perhaps a name associated with that telephone number, and the displayed name may be inaccurate. For example, a first person might use a second person's telephony device to place a call to a called party. In that instance, the called party would think that the second person is calling, when in fact it is the first person.

Moreover, there are times when caller ID information is not even available to the called party. This can occur when there are problems with the transmission or delivery of the caller ID information, which often occurs during international calls where multiple different types of telephony systems are interacting with one another to setup the call. Also, in some instances the calling party deliberately blocks the caller ID information so that the called party is unable to learn the telephone number from which the calling party is placing the call. In these instances, no information is available to the called party.

### BRIEF DESCRIPTION OF THE DRAWINGS

FIG. 1 is a diagram of a communications environment including various elements which are associated with an Internet protocol (IP) telephony system operating in accordance with the invention;

FIG. 2 is a block diagram of a processor that forms part of an IP telephony system;

FIG. 3 is a block diagram of an announcing unit that acts to provide a called party with a message or information from the calling party;

FIG. 4 is a flowchart illustrating steps of a first method embodying the invention in which a message is delivered to a called party before the called party is connected with the calling party;

FIG. 5 is a flowchart illustrating steps of a second method embodying the invention in which a message is delivered to the called party before the called party is connected to the calling party;

FIG. 6 is a flowchart illustrating steps of a third method embodying the invention in which information provided by a calling party is used to determine how to automatically handle a telephone call;

FIG. 7a is a block diagram representation of a call activation interface on an a software platform;

FIG. 7b is a block diagram of a call activation interface embodying the invention to automatically handle a telephone call on the software platform; and

FIG. 8 is a flowchart illustrating steps of another method embodying the invention in which an interface is provided on an software platform to automatically handle a telephone call.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text and video communications using Internet protocol data communications.

In the following description, references will be made to an “IP telephony device.” This term is used to refer to any type of device which is capable of interacting with an IP telephony system to complete a telephone call. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

Moreover, certain devices that are not traditionally used as telephony devices may act as telephony devices once they are configured with appropriate application software. Thus, some devices that would not normally be considered telephony devices may become telephony devices or IP telephony devices once they are running appropriate software.

The following description will also refer to telephony communications and telephony activity. These terms are intended to encompass all types of telephone calls, including video calls, regardless of whether all or a portion of the calls are carried in an analog or digital format. These terms are also intended to encompass data communications that are conveyed through a PSTN or VOIP telephony system, such as facsimile transmissions, text messages, SMS messages, MMS messages, video messages, and all other types of data communications sent by or received by a user. In other words, these terms are intended to encompass any communications whatsoever, in any format, which traverse all or a portion of a communications network or telephony network.

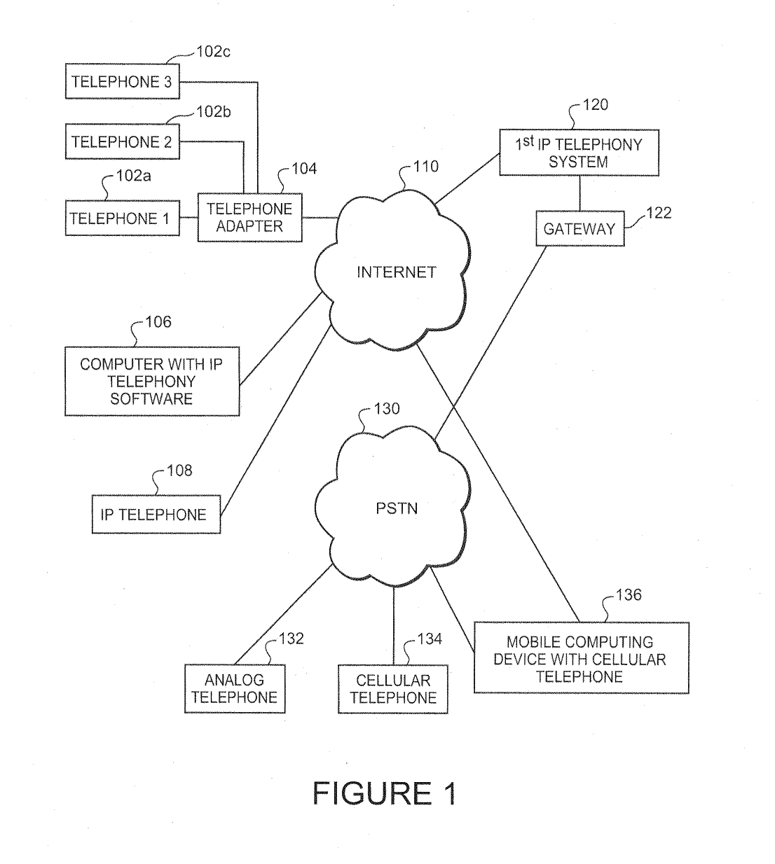

As illustrated in FIG. 1, a communications environment is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a first publicly switched telephone network (PSTN) 130 via a gateway 122. The first PSTN 130 may also be directly coupled to the Internet 110 through one of its own internal gateways (not shown). Thus, communications may pass back and forth between the first IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize a normal analog telephone 102a which is connected to the Internet 110 via a telephone adapter 104. The telephone adapter 104 converts analog signals from the telephone 102a into data signals that pass over the Internet 110, and vice versa. Also, as illustrated in FIG. 1, multiple analog telephone devices 102a, 102b and 102c could all be coupled to the same telephone adaptor 104. Analog telephone devices include but are not limited to standard telephones and document imaging devices such as facsimile machines. A configuration using a telephone adapter 104 is common where all of the analog telephone devices 102a, 102b and 102c are located in a residence or business, and all of the telephone devices are connected to the same telephone adapter. With this type of a configuration, all of the analog telephone devices 102a, 102b, 102c share the same telephone number assigned to the telephone adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 would then route the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In addition, mobile computing devices which include cellular telephone capabilities could also be used to place telephone calls to customers of the IP telephony system. A mobile computing device 136, as illustrated in FIG. 1, might connect to the PSTN 130 using its cellular telephone capabilities. However, such devices might also have the ability to connect to a data network, such as the Internet 110 wirelessly via some other means. For instance, a mobile computing device 136 might communicate with a wireless data router to connect the mobile computing device 136 directly to a data network, such as the Internet 110. In this instance, communications between the mobile computing device 136 and other parties could be entirely carried by data communications which pass from the mobile computing device 136 directly to a data network 110. Of course, alternate embodiments could utilize any other form of wireless communications path to enable communications.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

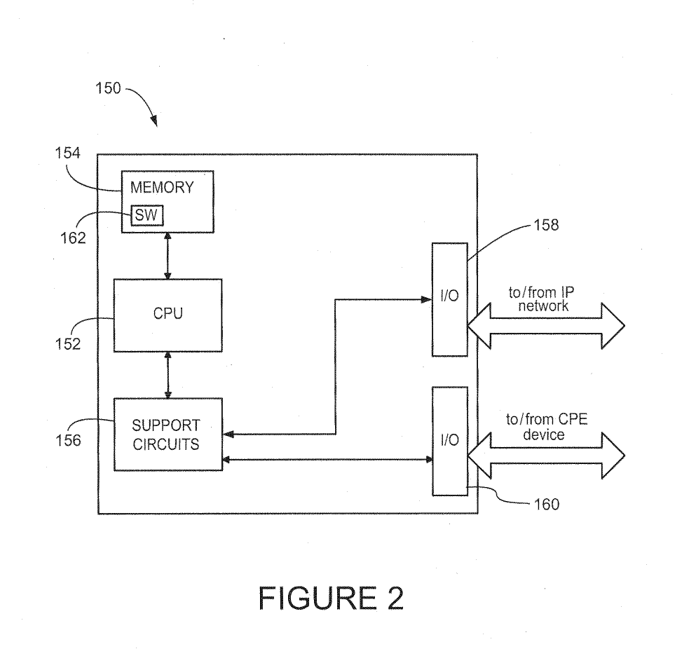

FIG. 2 illustrates elements of a computer processor 150 that can be used as part of the IP telephony system 120 to accomplish various functions. The IP telephony system 120 could include multiple processors 150 located at various locations in the system, along with their operating components and programming, each carrying out a specific or dedicated portion of the functions performed by the VOIP based telephony service 120.

The processor 150 shown in FIG. 2 may be one of any form of a general purpose computer processor used in accessing an IP-based network, such as a corporate intranet, the Internet or the like. The processor 150 comprises a central processing unit (CPU) 152, a memory 154, and support circuits 156 for the CPU 152. The processor 150 also includes provisions 158/160 for connecting the processor 150 to customer equipment and to service provider agent equipment, as well as possibly one or more input/output devices (not shown) for accessing the processor and/or performing ancillary or administrative functions related thereto. The provisions 158/160 are shown as separate bus structures in FIG. 2; however, they may alternately be a single bus structure without degrading or otherwise changing the intended operability of the processor 150.

The memory 154 is coupled to the CPU 152. The memory 154, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 156 are coupled to the CPU 152 for supporting the processor in a conventional manner. These circuits include cache, power supplies, clock circuits, input/output circuitry and subsystems, and the like.

A software routine 162, when executed by the CPU 152, causes the processor 150 to perform processes of the disclosed embodiments, and is generally stored in the memory 154. The software routine 162 may also be stored and/or executed by a second CPU (not shown) that is remotely located from the hardware being controlled by the CPU 152. Also, the software routines could also be stored remotely from the CPU. For example, the software could be resident on servers and memory devices that are located remotely from the CPU, but which are accessible to the CPU via a data network connection.

The software routine 162, when executed by the CPU 152, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 162 of the disclosed embodiments is capable of being executed on any computer operating system, and is capable of being performed using any CPU architecture.

Another form of processor that assists in execution and is otherwise part of the subject invention is found within one or more of the mobile computing devices. Such devices are sufficiently advanced beyond early generation cellular telephones that they contain power processors capable of running operating systems developed by device manufactures as well as third party applications downloaded and installed by users for performing a myriad of communications and non-communications oriented tasks.

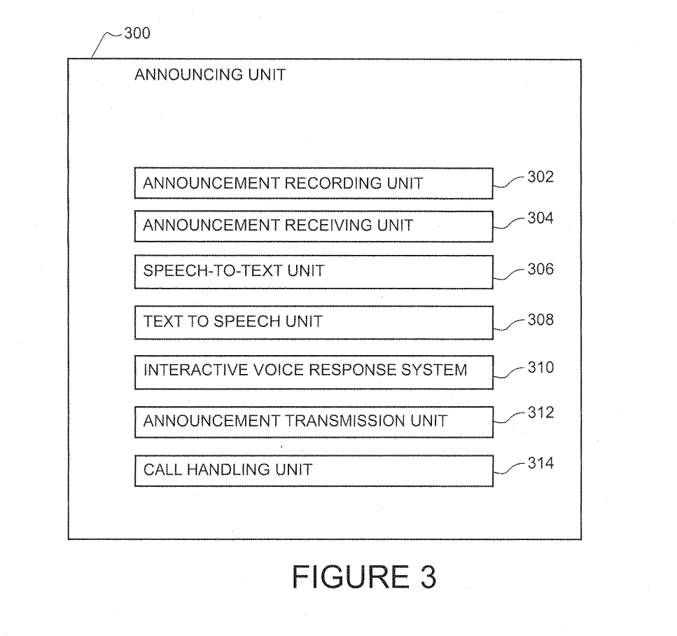

FIG. 3 is a block diagram illustrating elements of an announcing unit 300 which can cause a message to be played to a called party before the called party is connected to the calling party. The announcing unit 300 would be part of the IP telephony system 120 illustrated in FIG. 1. The announcing unit 300 allows a calling party to provide an announcement when the calling party is trying to establish a call with a called party. The information or message comprising the announcement is delivered to or played to the called party before the called party is connected to the calling party. The announcement helps the called party determine whether or not to answer the call. In some embodiments of the invention, the announcement provided by the calling party is used by the announcing unit 300 to determine how to automatically route or handle the call.

In some instances, the information or message is delivered to the called party as text. This typically means causing the text to be displayed to the called party on a display screen of the called party's telephony device. In other instances, the information or message could comprise an audio or a video recording. Here again, the audio or video recording would be played to the called party over the called party's telephony device before the called party is connected to the calling party. As will be described in detail below, the information or message could be obtained, captured or recorded in multiple different ways, and the message could be delivered to or played to the called party in multiple different ways.

In the case of text based messages or information, the calling party could input the message using a keypad of the calling party's telephony device. This can occur either before or after the calling party dials the telephone number of the called party. In this situation, the text of the message is provided from the calling party's telephony device to the announcement receiving unit 304 of the announcing unit 300 of the IP telephony system 120. The announcement transmission unit 312 of the announcing unit 300 then causes the text to be delivered to the called party's telephony device so that it can be displayed to the called party on a display screen of the called party's telephony device.

In some embodiments, the device used to enter the message is different from the device used to conduct the call. For example, in some embodiments, a user may enter the text of a message using a computer coupled to the data network, whereas the subsequent call may be conducted over a separate telephony device. The text of the message could be entered using a website configured for this task, and the user may have the option of triggering the call once the message has been entered using functionality provided by the website.

For example, in some embodiments, a user would navigate to a website provided by the IP telephony system, and the user would enter the message. The user would then select an icon to trigger the call. At this point, the announcement transmission unit 312 would cause the text of the message to be delivered to the called party's telephony device at the same time that a call is setup between the called party's telephony device and the called party's telephony device.

In a similar manner, the message that is displayed to the called party may be displayed on a device that is separate from the called party's telephony device. For example, a message sent from a calling party may displayed on the called party's computer display screen at the same time the incoming call is being setup to the called party's telephony device.

In situations where the calling party is unable to enter a text based message, but where the calling party desires a text based message to be delivered to the called party, the announcing unit 300 of the IP telephony system 120 could generate the text message. In one embodiment, an announcement recording unit 302 of the announcing unit 300 would record a spoken message provided by the calling party. Next, a speech-to-text unit 306 of the announcing unit 300 converts the calling party's spoken message into text. The text is then delivered to the called party's telephony device by the announcement transmission unit 312.

Of course, the same basic method could be used to record a spoken message that is to be played to the called party. In that instance, once the recording has been made by the announcement recording unit 302, the announcement transmission unit 312 could cause the audio message to be delivered to the called party's telephony device so that it can be played to the called party.

The recording of a spoken message could occur immediately after the calling party dials the telephone number of the called party. Although the calling party will have dialed the called party's telephone number, the announcing unit 300 would first answer the call. The announcing unit 300 would ask the calling party if the calling party wishes to have a message delivered to the called party. If the calling party agrees, the calling party would be prompted to provide a spoken message, and that spoken message would be recorded by the announcement recording unit 302. An interactive voice response system 310 of the announcing unit 300 could be used to guide the calling party through the process of recording a message that is to be delivered to the called party.

The recording of a video message could be accomplished in a similar fashion. Once the calling party has dialed the called party's telephone number, the announcing unit 300 answers the call and interacts with the calling party to determine if the calling party wishes to record a video message. Elements of the calling party's telephony device are used to capture the video stream, which would be communicated to the announcement recording unit 302. The announcement transmission unit 312 then delivers the recorded video message to the called party's telephony device so that it can be played to the called party.

In still other embodiments of the invention, the called party's telephony device may itself be capable of recording an audio or a video message. This could be accomplished via a software application running on the calling party's telephony device. The recordation of an audio or video message could be accomplished either before or after the calling party dials the called party's telephone number. Regardless, the pre-recorded audio or video message would be provided to the announcement receiving unit 304 of the announcing unit 300, and the announcing unit 300 would cause the obtained audio or video message to be delivered to the called party's telephony device so that it can be played to the called party.

In other embodiments of the invention, the calling party may be able to deliver a text based message to the announcing unit 300, but the calling party may wish for the message to be delivered to the called party as an audio message. In this situation, a text-to-speech unit 308 of the announcing unit 300 converts the text message provided by the calling party into a spoken or audio message. That audio message is then delivered to the called party's telephony device so that it can be played to the called party. Here again, the interactive voice response system 310 of the announcing unit 300 interacts with the calling party to determine how the calling party wishes for the message to be delivered.

In the embodiments described above, the calling party determines how the message should be played or displayed to the called party. In alternate embodiments, the called party may specify that messages are to be delivered in a certain fashion. For example, if the called party specifies that all messages should be delivered in an audio format, and the calling party provide a text message, the text-to-speech unit 308 would automatically convert the text based message into an audio message before the message is delivered to the called party's telephony device. Likewise, if the called party has specified that messages are to be delivered in a text format, the speech-to-text unit 306 would automatically convert any audio messages into text before the messages are delivered to the called party's telephony device.

In some embodiments, the interactive voice response system 310 of the announcing unit 300 could be used by a calling party to select one of a plurality of predetermined subjects for a call. For example, when the calling party dials the called party's telephone number, the interactive voice response system 310 first interacts with the calling party and asks if the calling party would like to select a subject for the call. The calling party then chooses a subject, and the announcement transmission unit 312 causes this information to be delivered to the called party before the called party must answer the call. This could include causing the selected subject to be displayed on a display screen of the called party's telephony device, or causing an audio or video recording about the selected subject to be played over the called party's telephony device.

Likewise, an application on the calling party's telephony device could allow the calling party to select a subject for the call, and the subject information could be provided to the announcing unit 300. The announcing unit then provides this information to the called party before the called party is connected to the calling party.

In the above embodiments, a subject for the call is selected by the calling party. In a similar fashion, the calling party may be able to indicate a level of importance or urgency for a telephone call. The calling party could utilize an application on the calling party's telephony device to select a level of importance or urgency, or the calling party could interact with the interactive voice response system 310 of the announcing unit 300 to select a level of importance or urgency. The announcement transmission unit 312 then causes the level of importance or urgency of the call to be communicated to the called party via a text display, or via an audio or video recording that is played to the called party.

The announcement transmission unit 312 could cause a message or information to be delivered and/or displayed/played to the called party in multiple different ways. In some embodiments, the message or information is delivered to the called party's telephony device as data packets over a data network connection. This could be accomplished by having the announcement transmission unit 312 transmit data packets bearing the message or information directly to the called party's telephony device. A software application on the called party's telephony device then displays or plays the message or information to the called party.

In alternate embodiments, the announcement transmission unit 312 stores the message or information at a particular location on a data network device, such as a server. The announcement transmission unit 312 sends a message to the called party's telephony device which includes an indication of where the message or information has been stored. The indication could be a universal resource locator (URL) which is used by the called party's telephony device to retrieve and display or play the stored message or information.

In still other embodiments, the message or information is delivered to the called party's telephony device via a SMS, MMS or text message. A software application on the called party's telephony device might cause the received information to be displayed or played to the calling party in a fashion other than a typical SMS, MMS or text message, even through the data has been communicated in that fashion. If the called party's telephony device is a mobile computing device with telephony capabilities, such as an Apple iPhone™, a push notification service could also be used to deliver the message or information to the called party's telephony device. For example, the Apple Push Notification Service (APNS) provides a way of delivering text-based messages to a called party's telephony device.

Further, where a push notification service is used to deliver the message to the called party's telephony device, the push notification service message might also include the display of “Accept” and “Decline” buttons or icons. In this instance, the called party would first view the message delivered through the push notification. After reviewing the message, the user could press the “Accept” button to answer the call, or the “Decline” button to decline the call. Pushing the “Accept” button would activate a software application on the called party's telephony device which then arranges for the connection of the call.

In still other embodiments, the announcement transmission unit 312 could send a communication, such as an email, to the called party's telephony device. The e-mail itself could include the message or information. Alternatively, a file bearing the message or information could be attached to the e-mail. In some instances, an application resident on the called party's telephony device would then arrange for the display or play of the message or information.

Regardless of how the message or information is delivered to the called party's telephony device, the called party's telephony device displays or plays the message or information to the called party before the called party is connected to the calling party. This gives the called party an opportunity to use the message or information to determine whether to accept the incoming telephone call.

The called party may be given options in addition to simply accepting or declining the call. For example, when the caller sees the message, the called party may be given the option to block all future calls from that calling party. This would provide the called party with a simple and easy way to block future calls from a telemarketer.

Where the called party is using an IP telephony device, and the call is to be setup as an IP telephone call between an IP telephony system 120 and the called party's telephony device, it is often possible to cause the calling party's message or information to be displayed or played to the called party before or while the called party's telephone begins ringing. This allows the called party to use the message or information to determine whether to answer the call.

In other instances, the called party is using a normal analog telephone that is connected to a PSTN, or a cellular telephone that receives service from a cellular service provider. In these instances, it may be necessary to setup a telephone call between the announcing unit 300 of the IP telephony system 120 and the called party's telephony device for the purpose of delivering the calling party's message or information. If the called party then decides to accept the call, the calling party can be bridged into the existing telephone call, or a second, separate call can be connected between the calling party and the called party's telephony device.

If a calling party provides information about the subject of a call, or about the importance or urgency of the call, this information could be used by the IP telephony system 120 to determine how to automatically handle the call. FIG. 3 illustrates that the announcing unit 300 may include a call handling unit 314 that performs this function.

For example, if the calling party provides an indication of the urgency or importance of the call, this information could be used by the call handling unit 314 to determine whether the call should even be connected through to the called party's telephony device. If the called party has instructed that calls having a low or medium level of importance are to be ignored, the call handling unit 314 of the announcing unit 300 could use the information provided by the calling party to determine how to route incoming telephone calls. Calls of higher importance would be connected, and calls of lower importance would be ignored, routed to voicemail, or treated in some other fashion.

Likewise, if the calling party provides one of a plurality of predetermined subjects for a call, the call handling unit 314 could use this information to determine whether the call should be completed to the called party's telephony device. This would allow the called party to identify those subjects where he would like to receive calls, and those subjects where he wishes for the calls to be ignored or placed into voicemail.

Determining how to handle calls based on subject matter would work if the calling party selects one of a set of predetermined subjects. In addition, if the calling party provides an audio or video message identifying the subject of a call, the call handling unit 314 could utilize speech recognition assets of the speech-to-text unit 306 to identify key words in the message provided by the calling party. If one of the key words matches one of the subjects recognized by the call handling unit 314, the call is then handled based on the called party's instructions.

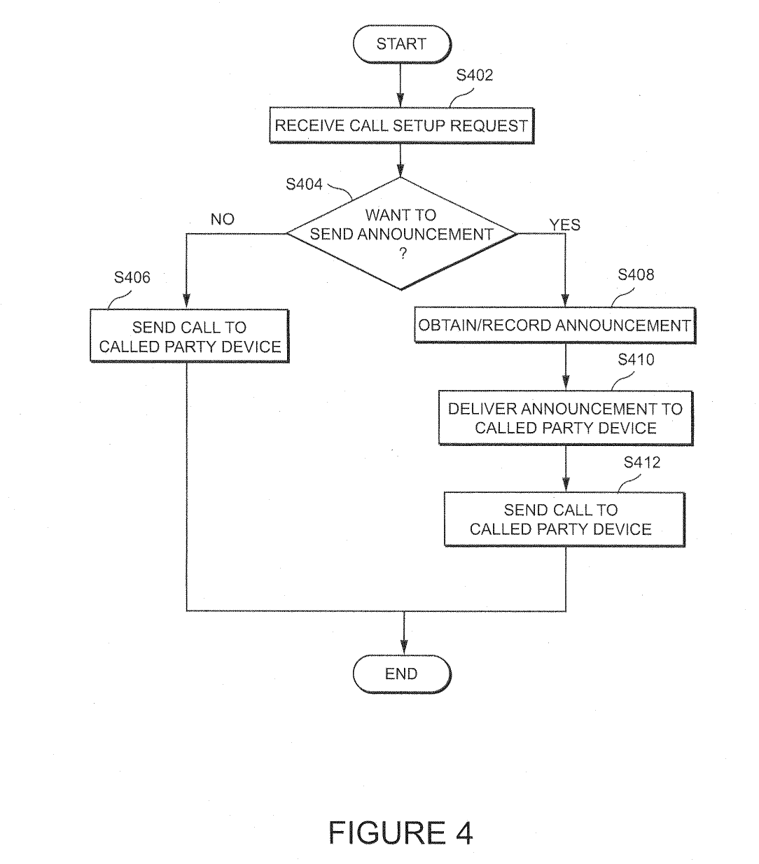

FIG. 4 illustrates steps of a first method embodying the invention. The method begins in step S402 when a call setup request is received by the IP telephony system 120. This could be a request from a calling party who is a customer of the IP telephony system 120 to reach a called party who is also a customer of the IP telephony system, or a called party who is a customer of a PSTN or cellular service provider 130. This could also be a request from a calling party that is customer of a PSTN or cellular service provider 130 to reach a customer of the IP telephony system 120.

In step S404, the announcing unit 300 asks the calling party if the calling party would like to send an announcement in the form of a pre-call message or information to the called party about the call. Specifically, an interactive voice response system 310 could ask the calling party if the calling party wishes to send an announcement to the called party about the call.

If the called party declines to send an announcement, in step S406 the call is sent to the called party's telephony device in the typical manner. While the called party's telephony device might be able to display caller ID information, no additional message or information would be provided to the called party.

If the calling party agrees to send an announcement in step S404, the method proceeds to step S408, where the announcing unit 300 obtains or records a message or information. As explained above, this could include obtaining a text, audio or video message provided by the calling party via the calling party's telephony device. Alternatively, the announcing unit 300 could record a text, audio or video message which is to be delivered to the called party. Further, the announcing unit 300 might convert a text message provided by the calling party into an audio message, or vice versa, depending on instructions from the calling party, or preferences of the called party.

In step S410 the announcement transmission unit 312 of the announcing unit 300 causes the announcement to be delivered to the called party. As explained above, the announcement could be delivered to the called party's telephony device through multiple different means, and the message or information could then be displayed or played to the called party. A software application on the called party's telephony device could coordinate the displaying or playing of the message or information. Likewise, a software application on the called party's telephony device could obtain the message or information from a storage location based on information received from the announcing unit 300, and then coordinate the display or playing of the message or information.

In step S412, the calling party is connected to the called party's telephony device. Because the called party will have already received the announcement provided by the calling party, the called party is able to use the message or information to determine whether to answer the call.

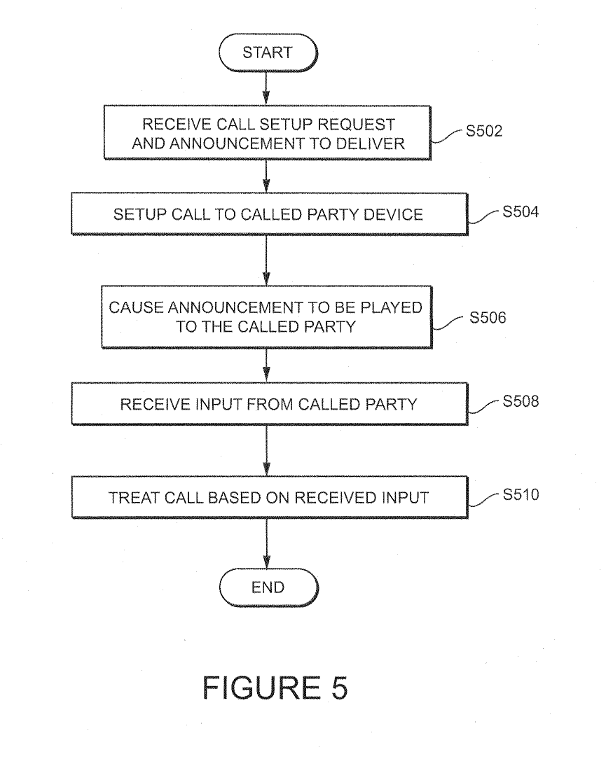

FIG. 5 illustrates steps of another method embodying the invention. FIG. 5 is applicable to situation where the called party has a telephony device which will not allow a message to be delivered and played to the called party before a telephone call is actually established with the called party's telephony device. This can occur in instances where the called party is not a customer or user of the IP telephony system (i.e., a customer of a PSTN or cellular service provider 130).

The method begins in step S502 when the IP telephony system 120 receives a call setup request, and an announcement which is to be delivered to the called party. The calling party's telephony device could provide the announcement to the IP telephony system. Alternatively, the announcement recording unit 302 and/or an interactive voice response system 310 of the announcing unit 300 might interact with the calling party to record or otherwise obtain the announcement.

In step S504, the IP telephony system 120 sets up a telephone call to the called party's telephony device. For example, this could involve the IP telephony system 120 establishing a telephone call with an analog telephone 132 via the gateway 122 and the PSTN 130.

In step S506, when the called party answers the call, the announcing unit 300 first plays to the called party the obtained announcement provided by the calling party. This could include having the interactive voice response system 310 interact with the called party to deliver the announcement.

In step S508, the IP telephony system 120 asks the called party if the called party wishes to receive the call from the calling party. The IP telephony system then receives input from the called party. The called party could provide input by pushing one or more buttons on a keypad of the called party's telephony device. Alternatively, the called party could provide spoken input which is interpreted by the IP telephony system. Receiving input from the called party could include the interactive voice response system 310 interacting with the called party.

In step 510, the IP telephony system 120 then treats the call based on the input received from the called party. If the called party does not wish to speak to the calling party, the IP telephony system 120 could route the calling party to voicemail or to an alternate telephone number. If the called party does wish to speak with the calling party, the calling party could be bridged into the call already established to the called party's telephony device. Alternatively, the original call used to deliver the calling party's message or information could be ended, and a new call could be placed to the called party's telephony device.

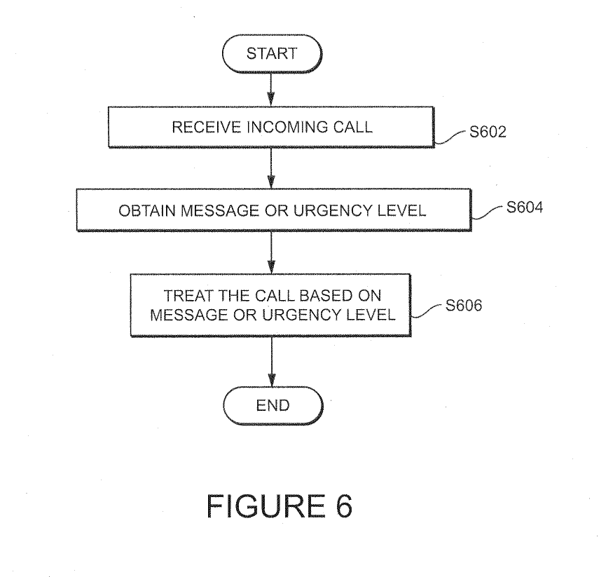

FIG. 6 illustrates steps of another method embodying the invention which makes use of the call handling unit 314. The method begins in step S602 when the IP telephony system 120 receives an incoming call from a calling party. In step S604, the announcing unit 300 obtains an announcement from the calling party. This could be done via any of the methods discussed above. In step S606, the call is treated based on the information provided by the calling party. As explained above, the call handling unit 314 of an announcing unit 300 could compare an urgency or importance level identified by the calling party to preferences identified by the called party to determine whether or not the called should be connected to the called party's telephony device. In addition, the call handling unit 314 could compare subject information provided by the calling party to a list of subjects identified by the called party to determine if the call should be connected to the called party's telephony device.

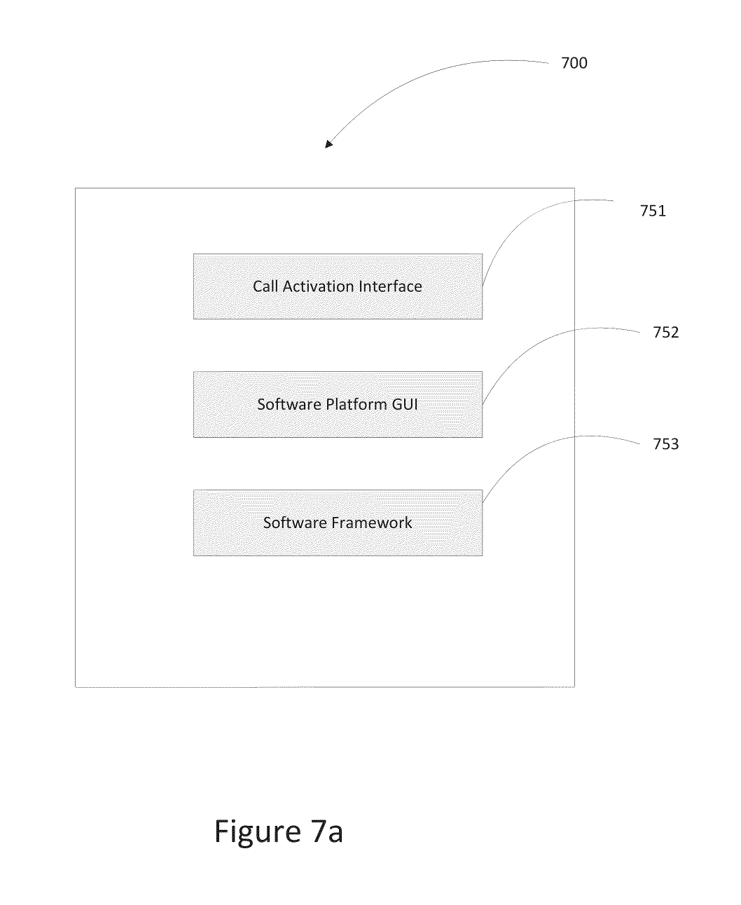

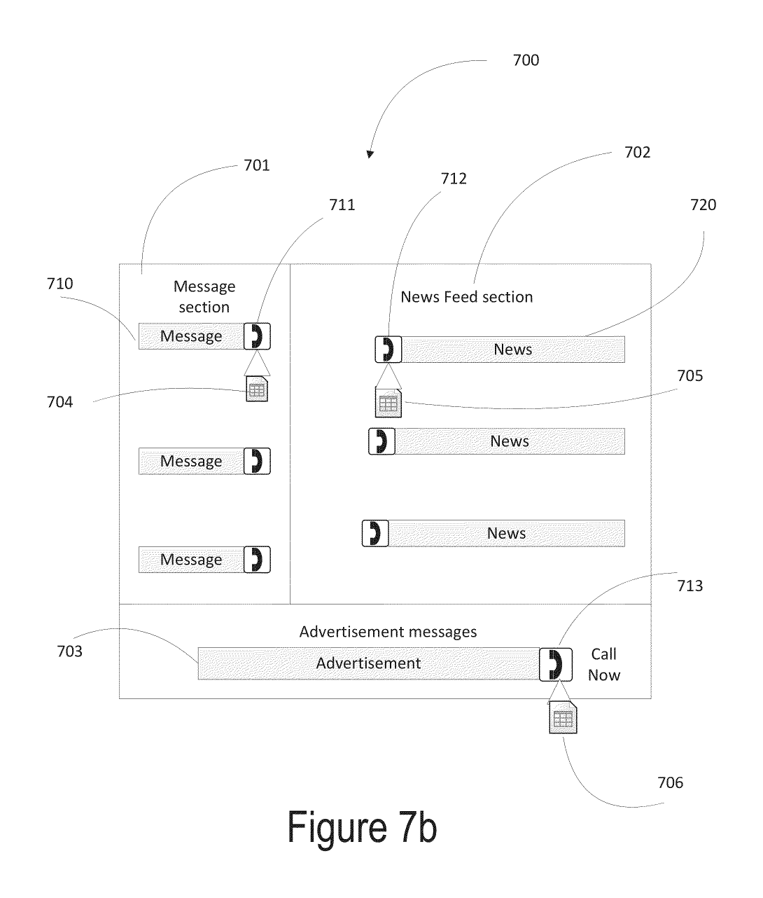

FIG. 7a is a block diagram representation of elements of a software platform 700 that includes a call activation interface 751 embodying the invention. Software platform 700 includes a native GUI interface 752 running on software framework 753. The call activation interface 751 is implemented on top of the native GUI 752 of the software platform 700.

FIG. 7b further illustrates the exemplary software platform 700 embodying the invention. Software platform 700 includes the call activation interface 751, which is accessed through call buttons 711, 712 and 713 appearing on the software platform 700. Call buttons 711, 712 and 713 are associated with discrete items on the software platform 700. The software platform 700 may include, for example, a message section 701; news feed section 702; and advertisements 703. Call buttons 711, 712 and 713 may then be associated, respectively, with one or more messages 710, one or more news items 720, one or more advertisements 703 and the like discrete items in these sections. Activation of call buttons 711, 712 and 713 may prompt the display of a list 704, 705 and 706 of possible contacts that may be called regarding the respective associated discrete item.

FIGS. 7a and 7b are meant only as examples and are not intended as a limitation of the invention. Many variations may be employed in embodiments of the invention. For instance, the sections, layout, labeling and graphics may vary widely. FIGS. 7a and 7b merely provide examples to illustrate the embodiments of the invention.

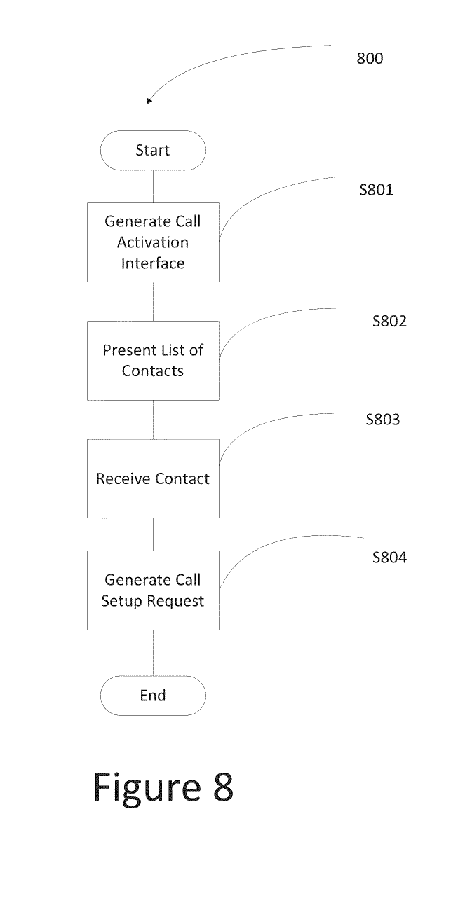

FIG. 8 illustrates a method 800 for delivering a message which makes use of the software platform 700. Referring to FIGS. 7b and 8, a call activation interface 751 is generated at step S801 that runs on the software platform 700. One skilled in the art would understand that the software platform 700 may be any software platform, such as a webpage, a browser, a document or file management system or the like. The call activation interface 751 generated at step S801 may include call buttons (711, 712 and 713) to enable a call setup on the software platform 700. At step S802, a selected call button (711, 712 and 713) would then trigger display of a list (704, 705 and 706) of possible contacts. The list (704, 705 and 706) may include a personal contact list, a contact associated with an item on the software platform 700, or other lists of available contacts with which a call can be set up. At step S803, at least one selected contact is received by the interface 751 for a call setup. At step S804, a call setup request directed to the at least one selected contact is generated by the methods discussed above.

In one exemplary embodiment, a message item 710 may include a conversation among several contacts. When call button 711 is selected, a list 704 will be displayed, comprising contacts participating in the message item 710. The associated contacts may include the participants in the conversation and may further be prioritized by frequency of posts, by particular participants relevant to the conversation, participants involved in more recent posts, or participants whose post were direct replies to those of a user accessing the software platform.

In another embodiment, a call button 712 on a news item 720 may prompt the display of a personal contact list 705 of persons that may be called about the news item 720. List 705 may include contacts who have read the article, author of the article, or contacts that demonstrate an affinity to the subject matter.

In another embodiment, an advertisement 703 may include a call button 713. In this case, call button 713 prompts the display of a list 706 which only lists the advertiser that posted the advertisement. The list may include a choice of local facilities of the advertiser, for example. Selecting a contact from the list 706 will generate a call setup as explained above in step S804 in accordance with methods embodying the invention. The list may also (or alternatively) include contacts that may have an interest in the advertisement based on a demonstrated affinity for the subject of the advertisement.

The call setup step S804, may include an announcement message from announcing unit 300 that will include the subject matter included with the item associated with call buttons 711, 712 and 713. For example, an announcement message created for a call associated with a news item 720 will announce that the call is about the news item 720. In some embodiments, the announcement message may be pre-configured, such as by an advertiser. In other embodiments, the announcement message may be configured by the platform 700 or the call activation interface 751. The announcement message of an incoming call may appear, for example, in message section 701 or in a separate section of platform 700. As described above, the announcement message provides the opportunity to accept or reject the incoming call.

One example embodying the methods of the invention may include the call activation interface 751 running on a social media platform such as Facebook®. In this example, call buttons would appear in association with News Feed items, messages, advertisements or the like on the Facebook® webpage.

Another example embodying the methods of the invention may include the call activation interface 751 running on a document management system. In this example, the call button would be associated with available documents. A list would be generated as described above in step S802 listing relevant contacts. Contacts may include the author(s), persons who have accessed the document, persons editing the document, and authors and editors of previous versions of the document, for example.

Another example embodying the methods of the invention may include a call activation interface 751 running on a search engine. In this case, the call button would be associated with search results. A list of available contacts would be generated as in step S802 that may include owners of advertisements, businesses, authors (books, blogs, articles, etc.) and personal contacts that show an affinity for the subject of a givensearch result.

Yet another example embodying the methods of the invention may include a call activation interface 751 running on a marketplace or retail site. In this case, the call button would be associated with the seller or retail establishment associated with a sale item on the site. A list of available contacts on a selected item would be generated as in step S802 and may include the business itself, local outlets of the business, sales persons and personal contacts that have an affinity with the market place, retailer, or product type.

In another embodiment, the call handling unit 314 could compare subject information provided by the calling party to a list of subjects identified by the called party to determine if the subject is associated with an item. The subject matter associated with the item may help determine the list of contacts S802. In addition, the call button may appear different depending on the subject matter. For example, the call button may be greyed out to indicate that the call cannot be established due to the subject matter. Similarly, the call button may change color or some other aspect of the call button to indicate the urgency, importance or other aspect of the item.

In another example embodying methods of the invention, the call button may be replaced by a “call now” button. In this case, call button will not generate a list of contacts as explained above in step S802 but will immediately generate a call setup request as in step S804. As an example, an advertiser may want to facilitate the call setup to the advertiser's business and enable an immediate call setup request.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A computer implemented method of delivering a message, comprising:
generating a call activation interface associated with at least one discrete item of a software platform; and
generating a call setup request directed to at least one contact associated with the at least one discrete item.

2. The method of claim 1, wherein the call setup request includes an announcement message.

3. The method of claim 2, wherein the announcement message comprises information associated with the discrete item.

4. The method of claim 1, wherein the software platform comprises a social media site, a document management system, a search engine, or a marketplace site.

5. The method of claim 1, wherein the at least one discrete item comprises a news item, a message, a document, a search result, a product or an advertisement.

6. The method of claim 1, wherein the at least one contact comprises a personal contact, a participant in an online discussion, an advertiser, an author or a business associated with the discrete item.

7. The method of claim 6, wherein the at least one contact further comprises a contact with an affinity for a subject of the discrete item.

8. A computer implemented method of delivering a message, comprising:
generating a call activation interface associated with at least one discrete item of a software platform;
presenting a list comprising at least one contact in response to a selection of the call activation interface;
receiving at least one selection of a contact from the list; and
generating a call setup request directed to the at least one selection of a contact

9. The method of claim 8, wherein the call setup request includes an announcement message.

10. The method of claim 9, wherein the announcement message comprises information associated with the discrete item.

11. The method of claim 8, wherein the software platform comprises a social media site, a document management system, a search engine, or a marketplace site.

12. The method of claim 8, wherein the discrete item comprises a news item, a message, a document, a search result, a product or an advertisement.

13. The method of claim 8, wherein the list comprises a personal contact, a participant in an online discussion, an advertiser, an author or a business associated with the discrete item.

14. The method of claim 13, wherein the list further comprises a contact with an affinity for a subject of the discrete item.

15. The method of claim 13, wherein the list is prioritized by frequency of posts, relevancy of participants, participants of recent posts, or direct reply participants.
